(19) United States
(12) Patent Application Publication
(10) Pub. No.: US 2007/0181698 A1
(43) Pub. Date: Aug. 9, 2007

(54) Portable programmable memory device insertable into a computer controlled display system with apparatus for recognizing computer display system and displaying dialog prompting selection of featured files for the system

(76) Inventor: Jeff K. Wilson, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/351,021

(22) Filed: Feb. 9, 2006

(51) Int. Cl. G06K 19/06

(52) U.S. Cl. 235/492

(57) ABSTRACT

A portable memory device operatively insertable into a computer controlled display system that comprises apparatus, responsive to said insertion of the memory device, for recognizing the computer controlled display system inserted into and combined with means that, upon recognizing this computer controlled display system, enable the computer controlled display system to, selectively access any data file in a predetermined set of data files in the memory device. There are further means also responsive to the recognizing of the computer controlled display system for immediately displaying a prompting dialog including a set of selectable objects, each representing a corresponding data file in the predetermined set of data files.

### TECHNICAL FIELD

The present invention relates to portable programmable memory devices, e.g. sticks and cards that are insertable into receiving slots in computer display systems. These portable memory devices provide a detachable memory personalized for the user.

### BACKGROUND OF RELATED ART

The past generation has been marked by a technological revolution driven by the convergence of the data processing industry with the consumer electronics industry. The effect has, in turn, driven consumer electronics technologies that have been known and available but relatively quiescent over the years to now come into great demand in the marketplace.

The rapid expansion in the capacity of computers to perform support functions, the greater and greater miniaturization of computers, as well as reduction in costs to perform memory and computer operations has opened the door for computer controller consumer instrumentation. A key aspect of this expansion has been lower and lower cost memory. In recent years this has been manifested in flash memory cards and sticks. At the current technology stage, these memory cards and sticks are detachably inserted into computers and computer controlled systems electronic instruments to provide an extra memory capacity of from one to five gigabytes. Memory cards use a flash memory that is based upon EEPROM (electrically erasable programmable read only memory) grid chips. Flash memory EEPROM works much faster than conventional EEPROM. Instead of erasing one byte at a time, it erases an entire block or an entire chip at a time and then rewrites. Smartmedia and Compactflash provide the “electronic film” for digital cameras while the Sony memory stick is quite popular in digital cameras and for computer controlled video games. These high capacity memory cards and sticks have been performing hard drive storage functions for the above-described computer controlled electronic instruments.

In this connection, the SSFDC (solid state floppy disc card) developed by Toshiba Inc. may function as the above-described Smartmedia card. Similarly, the above CompactFlash is a small circuit board with at least one flash memory chip and a dedicated controller chip encased in a housing or shell.

With this rapid expansion of the use of detachable memory cards for an increasing variety of computers and controlled electronic instruments, the cards themselves are becoming more easily carried around by users, e.g. key drives or memory sticks are carried by users and may be analagous to an electronic briefcase with a much higher capacity than a document briefcase.

### SUMMARY OF THE PRESENT INVENTION

Like the carried document briefcase, there is often a need for the owner or user to show or share specific documents or folders/files in and electronic briefcase, i.e. portable memory device with others. This is relatively convenient to do since these portable electronic devices are insertable into any computer or electronic computer controlled instruments, e.g. electronic cameras/viewers or hand-held audio music devices through ports such as USB ports. However, continuing the analogy to the document briefcase where the owner does not give the whole briefcase to another without regard to protecting some of the contents, in the case of the portable memory device of the present invention, the owner needs to protect at least some of the contents in the memory. The present invention provides an easy to use and convenient implementation that provides for the needs described above.

In accordance with this invention, there is provided a portable memory device operatively insertable into a computer controlled display system that comprises means, responsive to said insertion of said memory device, for recognizing the computer controlled display system into which the memory device is inserted combined with means which, upon recognizing this computer controlled display system, enable the computer controlled display system to selectively access any data file in a predetermined set of data files in the memory device. There are further means also responsive to the recognizing of the computer controlled display system, for immediately displaying a prompting dialog including a set of selectable objects, each representing a corresponding data file in the predetermined set of data files.

In addition, an implementation is provided in which there are files in the memory device that the owner does not wish to provide access to by others, and the owner is enabled to make such data files inaccessible to the recognized computer controlled display system. The owner of the memory device has discretion as to which computer systems receiving the inserted memory device are to have which files. Thus, there are situations wherein data files inaccessible to a particular recognized computer controlled display system are accessible to another recognizable computer controlled display system.

In one operative embodiment, the means for enabling upon recognition of the particular computer system enable the computer to selectively access any data file in a predetermined plurality of sets of data files in said memory device. In such a case, the prompting dialog includes means prompting an initial selection of one of the plurality of sets of data files; and the set of objects that is displayed responsive to this initial selection corresponds to the set of data files in the selected set of data files. Most conveniently, ports in computers receiving the portable memory devices are USB ports. The portable memory device may conveniently be in the form of any conventional flash memory or key drive. The portable memory device may also be wirelessly connected with the computer controlled display system.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of a memory card in accordance with the present invention being inserted into a computer controlled display system;

FIG. 2 is a diagrammatic view of a computer display screen on which the owner of an inserted portable memory device may program the portable memory device as to which files are to be featured in a prompting dialog, and which files are to be made inaccessible when the memory device is inserted into the computer of an identified user;

FIG. 3 is a diagrammatic view of the computer display screen presented to the identified user, programmed in the screen of FIG. 2, upon the insertion of the memory device into the computer of the identified user;

FIG. 4 is a block diagram of a simplified control circuitry on a portable memory device in accordance with this invention;

FIG. 5 is an illustrative flowchart describing the setting up of the elements of a program according to the present invention for programming a portable memory device to provide a selective prompt dialog of selected files when inserted into a recognized computer; and

FIG. 6 is a flowchart of an illustrative run of the program set up in FIG. 5.

### DETAILED DESCRIPTION OF THE PREFERRED EMBODIMENT

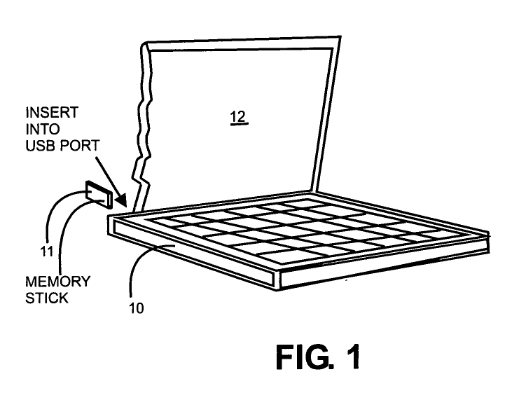

Referring to FIG. 1, a typical insertion of the portable memory device of the present invention, in the form of a memory stick or card 11 is inserted into a receiving port, e.g. USB port in computer 10 display 12 system.

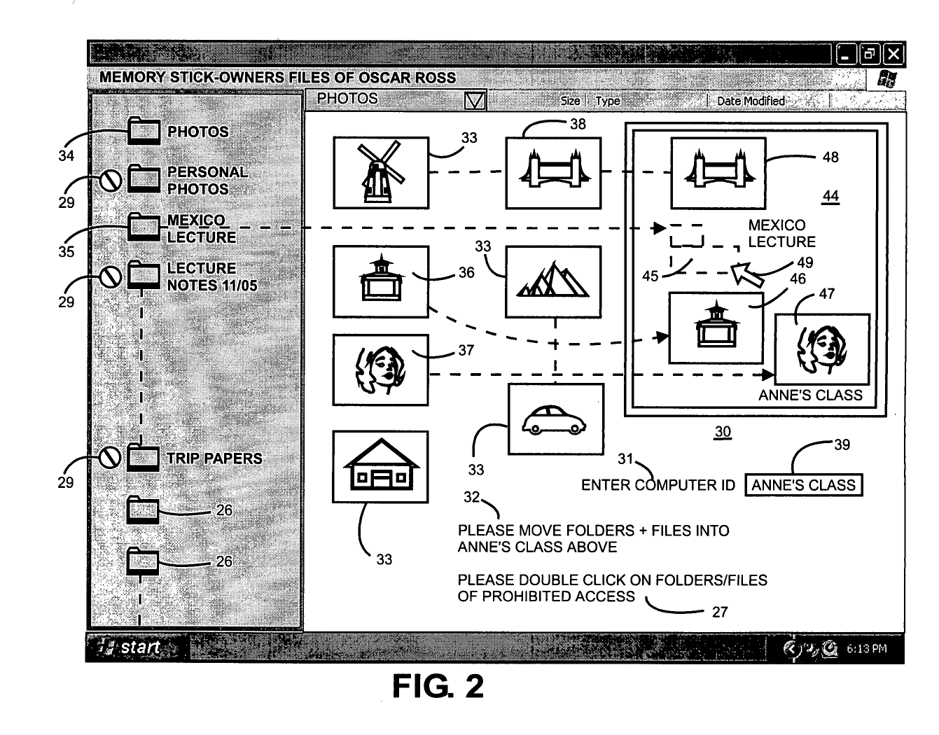

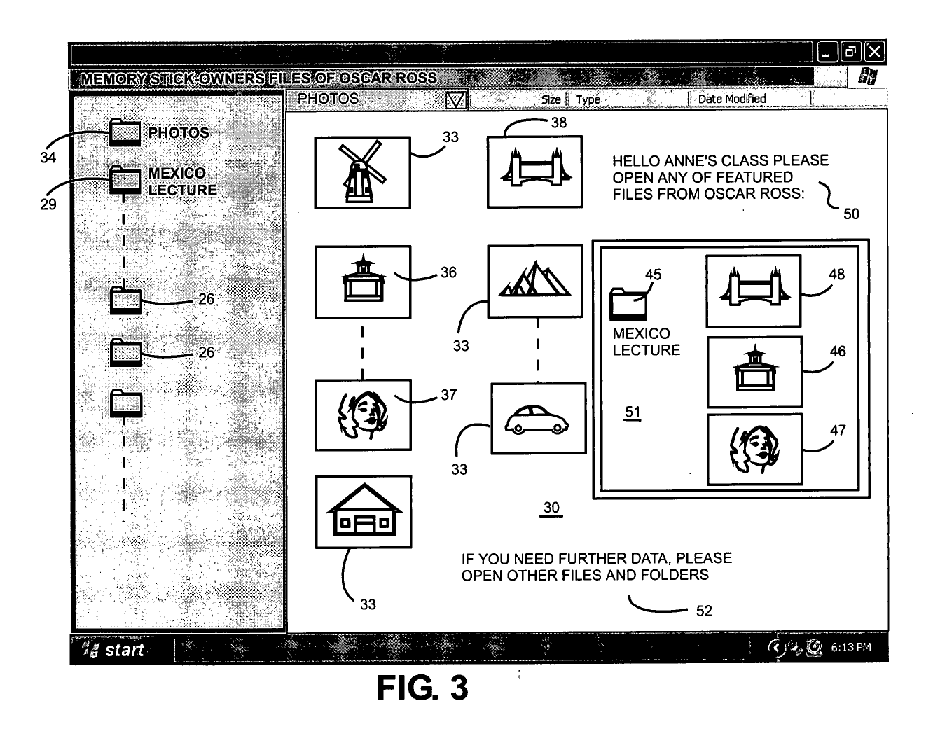

With reference to FIG. 2, there is shown a diagrammatic view of a computer display screen 30 on which the owner, “Oscar Ross” of an inserted portable memory device, may program the portable memory device as to which files are to be featured in a prompting dialog for a computer identified to be run in “Anne's Class”. In this situation, the owner has inserted his memory into any convenient display computer and, as will be subsequently described, the program on the memory stick has brought up screen 30 showing icons representing all of the folders 26, 34, 35 and the files 33, and 36 through 38 on the inserted memory stick. The screen also includes a container 44 designated “Anne's Class” into which any of the files and folders selected by the owner may be dragged and dropped using pointer 49 in a conventional “drag and drop” operation under mouse control. Let us assume that the owner intends to lend his memory stick to Anne's class so that selected files and folders may be used by the class. Accordingly, the program prompts the owner to enter an ID 31 for the designated computer and the owner has made the entry 39. Then, the owner is prompted 32 to move the files and folders that he wishes to feature into container 44. Accordingly, as shown by the dashed line paths, the owner has dragged and dropped icon 35 representing a Mexican Lecture folder into container 44 where it has become represented by featured icon 45. The owner has also dragged and dropped file icons 36, 37 and 38 into container 44 where they have respectively become featured filed icons 46, 47 and 48. These featured icons will be subsequently featured, as will be described in FIG. 3, when the memory stick is inserted into the computer recognized as “Anne's Class” computer. With the present memory stick, the users of the Anne's class computer will be able to access and open the data files represented by the other icons unless the owner prohibits such access. Thus, the owner is prompted 27 to double click on any folders or files to which access is to be prohibited. The owner, Oscar, has done this and prohibited access to three folders: Personal Photos, Lecture Notes 11/05, and Trip Papers as indicated by the No Entry icons 29 associated with the icons for these folders. By repeating this procedure, the owner may create special profiles for many identified computers. Such profiles remain stored in the memory stick so that the appropriate screen, as shown in FIG. 3, may be presented to the recognized computer upon the insertion of the memory stick into the receiving computer.

When the memory stick programmed described in FIG. 2 is inserted into the computer recognized as Anne's Class the display prompt screen in FIG. 3 comes up. The greeting 50 prompts the users to select any featured icon 45 through 49 to open the represented data file or folder in featured icon container 51. It should be noted that all files that the owner designated as prohibited with respect to FIG. 2 have been removed from the screen. Thus, the user may be prompted 52 to open any of the remaining files or folders if needed.

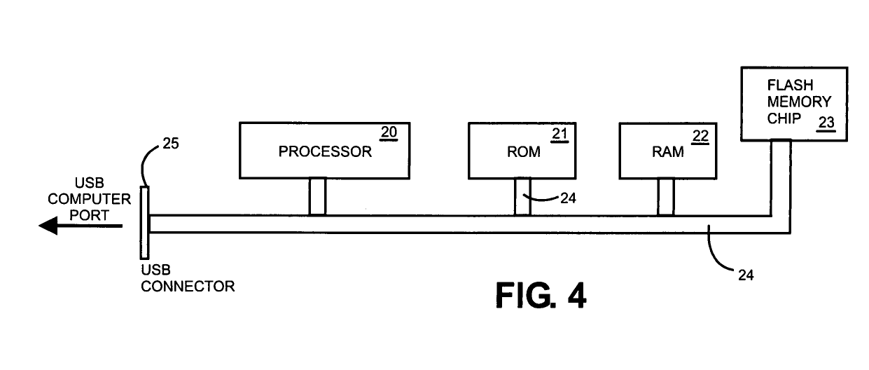

FIG. 4 is a block diagram of simplified control circuitry on controller integrated circuitry on a memory stick, card or key drive in accordance with this invention. The logic is usually provided by controller circuitry in the portable memory device to provide specific purpose logic to control the access, reading and writing into the flash memory array chips 23. This logic or control circuitry includes data processor 20, and operating systems stored in RAM 22 (about 4 MB of RAM are provided). A permanent programmable memory, a programmable ROM that may be an EEPROM, e.g. flash EEPROM, is included. All of the routines and programs may also be conventionally stored in this flash EEPROM 21. These include memory card operating systems and built-in applications including the programs of the present invention that may also be conventionally stored in the RAM. The logic circuitry also contains a system bus 24 connected via a USB connection 25 at one end to the conventional USB port of the receiving computer, and connected at the other I/O end to the flash memory EEPROM array IC chip 23.

While the invention has been described as connected with a USB connection, it should be understood that other conventional direct connections may be used. In addition, the invention is operative if the connection between the portable memory device and the receiving recognized display computer may be wireless, e.g. short range wireless connections over a 30 foot range if the portable memory device and the receiving computer can communicate, e.g. via respective Bluetooth protocol chips in each.

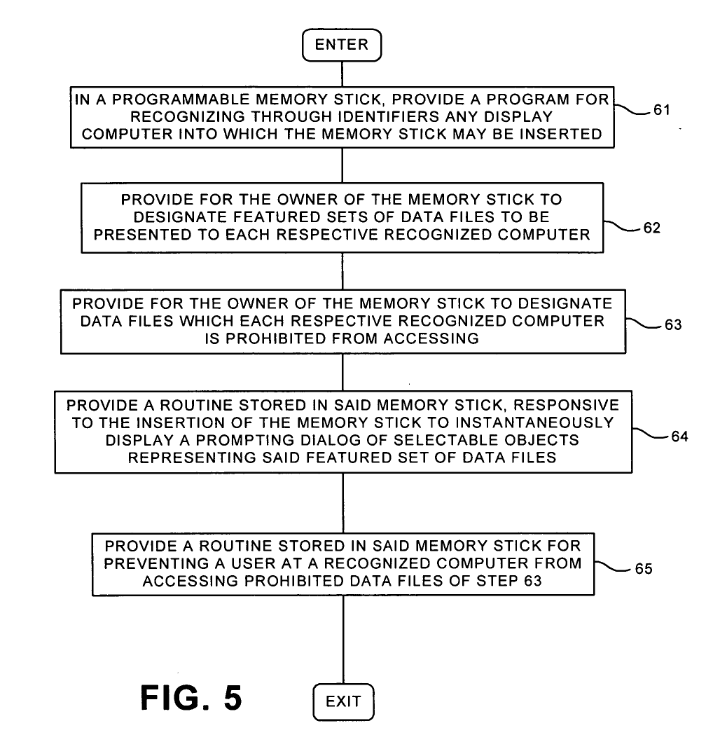

Referring now to FIG. 5, there is shown an illustrative flowchart in accordance with this invention describing the programming set up to enable an owner of a portable memory device to program the portable memory device as to which files are to be featured in a prompting dialog for each identified computer into which the owner's memory stick is to be inserted. Accordingly, step 61, in a programmable memory stick, there is provided a program for recognizing through appropriate identifiers, any display computer into which the memory stick may be inserted into. Provision is made for the owner of the memory stick to designate featured sets of data files to be presented to each respective recognized computer, step 62. Provision is also made for the owner of the memory stick to designate data files that each respective recognized computer is prohibited from accessing, step 63. Then there is provided a routine stored in the memory stick that is responsive to the insertion of the memory stick into a computer to instantaneously display a dialog of selectable objects representing the featured set of data files preselected by the owner of the memory stick for the particular recognized computer, step 64. There is also provided, step 65, a routine in the memory stick for preventing a user at any particular identified computer from accessing the prohibited data files of step 63.

In the illustration of the present invention, owner preselected files and folders have been used as the featured data components. It should also be understood that other criteria may be used in selecting such featured folders/files for the prompting dialog. For example, the features files may be the most recently accessed files or the most frequently accessed files. Also, the types of folders and files may be categorized and the featured files may be files known to be in areas of interest to the user at the recognized computer.

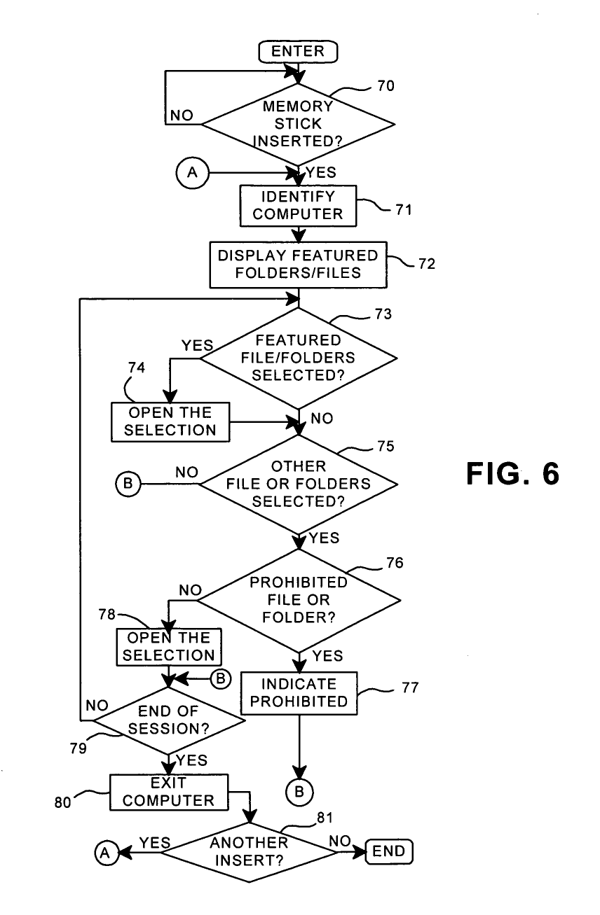

Now, with reference to the flowchart of FIG. 6, a simplified illustrative run of the process set up in FIG. 5 will be described. An insertion of the owner's memory stick into a computer controlled display is awaited, step 70. If Yes, the receiving computer is identified, step 71, and the prompt display of featured files and folders for the identified receiving computer is displayed, step 72. At this point, a determination is made, step 73, as to whether the user at the receiving terminal has selected a featured file or folder. If Yes, the selection is opened, step 74. Next, or if the determination in step 73 is No, a further determination is made as to whether a non-featured file or folder icon has been selected, step 75. If Yes, then a further determination is made, step 76, if the selected file is prohibited. If the decision in step 76 is Yes the file is prohibited, then, step 77, there is an indication on the display screen that access to the file is prohibited. If the decision in step 76 is No prohibition, then the selected file or folder is opened and displayed, step 78. At this point, or a No decision in step 75 via branch “B” or after step 77 via branch “B”, a decision may conveniently be made in step 79 as to whether the session is ended. If No, then the process is returned to step 73 via branch “A”. If Yes, this specific computer is exited, step 80. Then a decision is made, step 81, as to whether the memory stick has been inserted into another computer. If No, the sessions with the memory stick are ended. If Yes, the memory stick is inserted into another computer, then the process is branched via “A” to step 71 where the new computer is identified and the process is continued as described above.

Although certain preferred embodiments have been shown and described, it will be understood that many changes and modifications may be made therein without departing from the scope and intent of the appended claims.

What is claimed is:

1. A portable memory device operatively insertable into a computer controlled display system comprising:
means, responsive to said insertion of said memory device, for recognizing the computer controlled display system inserted into;
means, responsive to said recognition of said computer controlled display system, for enabling the computer controlled display system to selectively access any data file in a predetermined set of data files in said memory device; and
means, responsive to said recognition of said computer controlled display system, for displaying a prompting dialog including a set of selectable objects each representing a corresponding data file in said predetermined set of data files.

2. The portable memory device of claim 1 further including data files inaccessible to said recognized computer controlled display system.

3. The portable memory device of claim 2 wherein said data files inaccessible to said recognized computer controlled display system are accessible to another recognizable computer controlled display system.

4. The portable memory device of claim 2 wherein:
said means, responsive to said recognition of said computer controlled display system, for enabling the computer controlled display system to selectively access any data file in a predetermined plurality of sets of data files in said memory device;
said prompting dialog includes means prompting the initial selection of one of said sets of data files; and
said set of selectable objects is displayed responsive to said initial selection of one of said sets of data files and corresponds to the set of data files in said selected set of data files.

5. The portable memory device of claim 2 wherein memory device is insertable into a USB port in said computer controlled display system.

6. The portable memory device of claim 5 wherein said portable memory device is a flash memory device.

7. The portable memory device of claim 6 wherein said portable memory device is a key drive.

8. A portable memory device operatively connectable with a computer controlled display system comprising:
means, responsive to the connection of said memory device with said computer controlled display, for recognizing the connected computer controlled display system;
means responsive to said recognition of said computer controlled display system, for enabling the computer controlled display system to selectively access any data file in a predetermined set of data files in said memory device; and
means, responsive to said recognition of said computer controlled display system, for displaying a prompting dialog including a set of selectable objects each representing a corresponding data file in said predetermined set of data files.

9. The portable memory device of claim 2 further including data files inaccessible to said recognized computer controlled display system.

10. The portable memory device of claim 9 wherein said portable memory device is wirelessly connected to said computer controlled display system.

11. In a portable programmable memory device operatively insertable into a receiving computer controlled display system, a method for controlling access to data files in said memory device by designated receiving computer controlled display system comprising:
recognizing the receiving computer controlled display system inserted upon insertion of said memory device;
enabling the recognized computer controlled display system to selectively access any data file in a predetermined set of data files in said memory device designated for said recognized computer display system; and
displaying on said recognized display system, instantly upon recognition, a prompting dialog including a set of selectable objects each representing a corresponding data file in said predetermined set of data files.

12. The method of claim 11 further including the step of preventing said recognized computer controlled display system from accessing data files not in said predetermined set of data files.

13. The method of claim 12 wherein said data files not accessible to said recognized computer controlled display system are accessible to another recognizable computer controlled display system.

14. The method of claim 12 wherein:
said computer controlled display system is enabled to access any data file in a predetermined plurality of sets of data files in said memory device;
said prompting dialog prompts the initial selection of one of said sets of data files; and
said set of selectable objects in said prompting dialog corresponds to the set of data files in said selected set of data files.

15. The method of claim 12 wherein said portable memory device is a flash memory device insertable into a USB port in said computer controlled display system.

16. In a portable programmable memory device operatively insertable into a receiving computer controlled display system, a computer program for controlling access to data files in said memory device by designated receiving computer controlled display system comprising:
means, responsive to said insertion of said memory device, for recognizing the computer controlled display system inserted into;
means, responsive to said recognition of said computer controlled display system, for enabling the computer controlled display system to selectively access any data file in a predetermined set of data files in said memory device; and
means, responsive to said recognition of said computer controlled display system, for displaying a prompting dialog including a set of selectable objects each representing a corresponding data file in said predetermined set of data files.

17. The computer program of claim 16 further including data files inaccessible to said recognized computer controlled display system.

18. The computer program of claim 17 wherein said data files inaccessible to said recognized computer controlled display system are accessible to another recognizable computer controlled display system.

19. The computer program of claim 17 wherein:
said means, responsive to said recognition of said computer controlled display system, for enabling the computer controlled display system to selectively access any data file in a predetermined plurality of sets of data files in said memory device;
said prompting dialog includes means prompting the initial selection of one of said sets of data files; and
said set of selectable objects is displayed responsive to said initial selection of one of said sets of data files and corresponds to the set of data files in said selected set of data files.

20. The computer program of claim 16 wherein said portable memory device is a flash memory device insertable into a USB port in said computer controlled display system.
